(19) United States
(12) Patent Application Publication
(10) Pub. No.: US 2012/0278990 A1
(43) Pub. Date: Nov. 8, 2012

(54) ASSEMBLY TO PERFORM IMAGING ON RODENTS

(75) Inventors: Titus Lanz, Rimpar (DE); Michael Sauer, Rimpar (DE); Frank Resmer, Rimpar (DE)

(73) Assignee: RAPID BIOMEDICAL GMBH, Rimpar (DE)

(21) Appl. No.: 13/464,063

(22) Filed: May 4, 2012

Related U.S. Application Data
(60) Provisional application No. 61/483,256, filed on May 6, 2011.
(60) Provisional application No. 61/483,281, filed on May 6, 2011.

(51) Int. Cl. A61G 13/06

(52) U.S. Cl. 5/601

(57) ABSTRACT

An imaging device for imaging an anaesthetized animal such as a rodent (rats or mice or other), with the device having a split array coil providing at least two channels for use in a restraining assembly and animal bed for magnetic resonance imaging (MRI) the animal in real-time in a non-destructive manner.

### CROSS-REFERENCES TO RELATED APPLICATIONS

This application claims the benefit of U.S. provisional application Ser. No. 61/483,256 filed on May 6, 2011, incorporated herein by reference. This application also claims the benefit of U.S. provisional application Ser. No. 61/483,281 filed on May 6, 2011, and also incorporated herein by reference.

### BACKGROUND OF THE INVENTION

This application relates generally to an animal holding device for holding an animal during an imaging operation.

More specifically, this application relates to an apparatus and method including a restraining assembly for an anaesthetized rodent (rats or mice or other) in combination with a split array coil for magnetic resonance imaging (MRI) the animal in real-time in a non-destructive manner.

Rodents and other laboratory animals are often used for testing purposes. Such testing may involve the need to scan the animal using a scanning device, such as a SPECT, PET, CT, CAT, X-Ray, NMR/MR, or other imaging device, to provide real time and/or photographic images of the animal, which may be done in a non-destructive manner. It is often desirable to anesthetize such animals in order to completely immobilize the animal during the scanning process. Anesthetized animals, and in particular rodents, often cannot hold their body temperature at desired temperatures during such procedures, potentially leading to stress on the animal.

A system and method of maintaining the body temperature of immobilized animals in a consistent state while the animal is being anesthetized and/or while the animal is being scanned, or otherwise utilized by the testing process was disclosed in U.S. patent application Ser. No. 12/430,487, filed on Apr. 27, 2009, and incorporated herein by reference. Jürgen E. Schneider et al.: “Ultra-Fast and Accurate Assessment of Cardiac Function in Rats Using Accelerated MRI at 9.4 Tesla. Magnetic Resonance in Medicine” 59: 636-641 (2008), also incorporated herein by reference, discusses such concepts.

With live animals, it is always desirable to keep the time of the experiment as short as possible so that the stress on the animal is kept to a minimum. An assembly where the skull is fixed at the position of the animal's ears with two pins that form a stereotactic holder provides a stereotactic fixation such that the position of the animal's skull is well defined. The usual neurological set-up of a life animal incorporates a minimum of 3 positioning points. This is the bar to fixate the animal's teeth, and two pins for the locking of the skull via the animal's ears (left and right). However, it is often difficult to find the correct pressure to securely fixate the animal and lock it securely in one position and not harm the animal (e.g. perforate its ear drums). Due to the set-up from both sides of the animal's head, it is relatively time consuming to lock the animal head and to position it in the centre of the assembly, and so poses additional stress to the animal. The stereotactic set-up with ear pins also consumes valuable space and so limits the coil's filling factor.

A head coil assembly used in MRI imaging can be either carried out as a cylindrical volume coil enveloping the animal, or as a surface coil or surface array positioned directly on top of the animal head. This MR volume coil has clear advantages when good homogeneity is desired, as the image intensity is distributed relatively even over the volume. A good homogeneity is very important for qualitative measurements and QA set-ups. However the volume coil has a low sensitivity and the image SNR at the position of the animal brain is usually much lower than with a local surface coil positioned above the animal skull. Although the surface coil has clear SNR advantages over the volume coil, its signal sensitivity drops rapidly when moving away from the coil. So both, the penetration depth and the homogeneity of the surface coil are rather poor, and a small positioning error can lead to large changes in the signal intensity and can affect the measurement.

MR investigations of the animal's heart use a different set-up in comparison to neurological investigations of the animal brain. An assembly composed of one or more MR loops is housed inside a thin semi cylinder or a flat structure when imaging the heart. Here, the animal is usually positioned on top of the coil to reduce motion artefacts and also to minimize the distance of the coil to the animal's heart.

Desirable is a device for supporting the anesthetizing and scanning process that is compatible with desired scanning functions, such that the animal can be imaged in an optimum position and with a coil size that can be adjusted to the particular size of the animal's head for maximum filling factor and optimum signal-to-noise-ratio (SNR). Also desirable is positioning that can be reproduced in later experiments. It would also be useful to reduce or eliminate as much animal movement as possible to suppress motion artifacts during an MR experiment, and to reduce setup times to minimize the stress of the animals.

### SUMMARY OF THE INVENTION

Provided is a restraining assembly for an anaesthetized rodent (rats or mice or other) in combination with a split array coil for magnetic resonance imaging (MRI). In one example embodiment, the restraining assembly is designed for imaging the complete head, or alternatively the complete heart, of the animal. The assembly allows adjustment so that the animal can be imaged in an optimum position and so that the coil size can be adjusted to the particular size of the animal's head for maximum filling factor and optimum signal-to-noise-ratio (SNR). The positioning can be reproduced in later experiments. The assembly further includes parts that largely eliminate remaining animal movement and so suppress motion artefacts during an MR experiment.

The MR coil of an example embodiment includes two parts—a bottom part and a top part. The bottom part supports the animal skull (or the torso) and receives the MR signal from the lower part of the animal, whereas the coil's top part receives the MR signal from the upper part of the head or torso. One or more preamplifiers may be provided for each part, in some cases integrated in the parts themselves. In this example embodiment, both coil parts are integral parts of the restraining assembly; however these coil parts can also be removed from the set up. It is also possible to use only one of the two parts of the array without the other part. Each of the parts can provide one or more imaging channels. With the standard work flow the bottom part is usually kept assembled in the restraining assembly whereas the top part can be removed to allow a correct positioning of the animal. A pivot allows the final adjustment of the bottom part of the head coil so that the animal head is positioned directly against the top part for maximum filling factor and optimum signal to noise ratio (SNR).

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1: Sectional view of the restraining assembly held by the semi tube. The top part (1) and the bottom part (2) of the head coil are shown;

FIG. 2: Sectional view of the restraining assembly only with the bottom part (2) of the head coil;

FIG. 3: The assembly with the top part (1) and the bottom part (2) of the head coil including the positioning mechanism of the bottom part of the coil;

FIG. 4: The restraining assembly with the head coil bottom part. It is showing the anaesthetic gas unit 6, 7, 8, 10, 12) and the positioning mechanism of the bottom part (3, 4, 5). The anaesthetic unit as well as the head coil are connected to the head coil holder (17) which in turn is connected to the semi tube (15);

FIG. 5: A view of the restraining assembly without the coil. It shows the locking pins (3) to hold the bottom part of the head coil parts (1 & 2) in position;

FIG. 6: The anesthetic gas unit (6, 7, 8, 10, 12) in combination with the bottom part of the head coil;

FIG. 7: Sectional view of the assembly with the top part and the bottom part of the head coil in position. Unit 7a feeds the anaesthetic gas to the animal while the connector 7b emits the exhaled gas;

FIG. 8: The top view of the restraining assembly showing the anaesthetic gas unit (6, 7, 8, 10, 12) and the pivot (14) to allow the head coil top part to be hinged away from the assembly. Position 15 shows the slots where the anaesthetic gas pipes are running aside the animal;

FIG. 9: The mechanism to adjust the position of the bottom part of the head coil with the locking pin (3), the adjustment wheel (4) and the scale (5) for reproducible positioning.

FIGS. 10-49 are photographs of the example assembly in various views and put to various applications.

### DETAILED DESCRIPTION OF THE EXAMPLE EMBODIMENTS

Table 1 provides a table of the parts identified in the drawings.

TABLE 1

| | |
|---|---|
| 1 | top part of the array coil |
| 2 | bottom part of the array coil |
| 3 | locking pin including wings to pull outwards |
| 4 | adjustment wheel for positioning the bottom part of the array coil |
| 5 | scale on 4 for reproducible positioning |
| 6 | tooth bar to fixate the skull of the animal |
| 7 | anaesthetic gas mask |
| 7a | gas inlet |
| 7b | gas outlet |
| 8 | anaesthetic holder |
| 9 | scale for horizontal positioning of the anaesthetic holder |
| 10 | anaesthetic block for vertical adjustment |
| 11 | scale for vertical adjustment of the anaesthetic block |
| 12 | locking wheel to fix the positioning |
| 13 | pivot for bottom part of the array coil |
| 14 | pivot for top part of the array coil |
| 15 | semi tube to hold the assembly |
| 16 | animal couch |
| 17 | holder for the array coil |

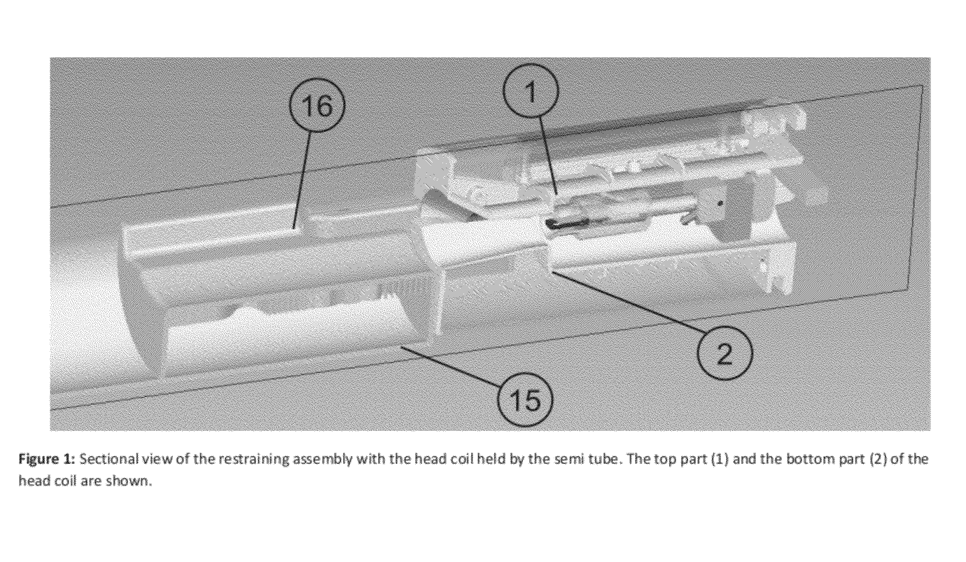

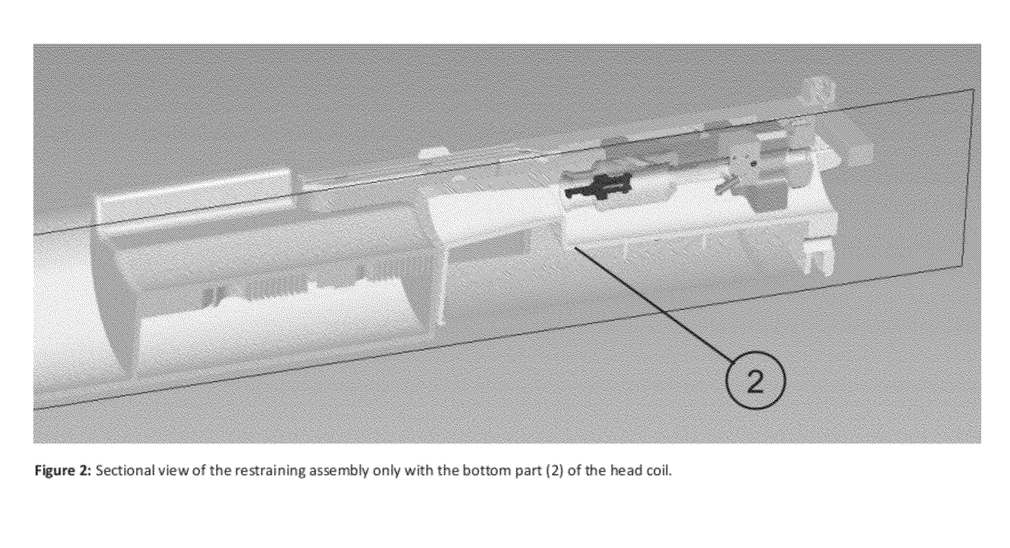

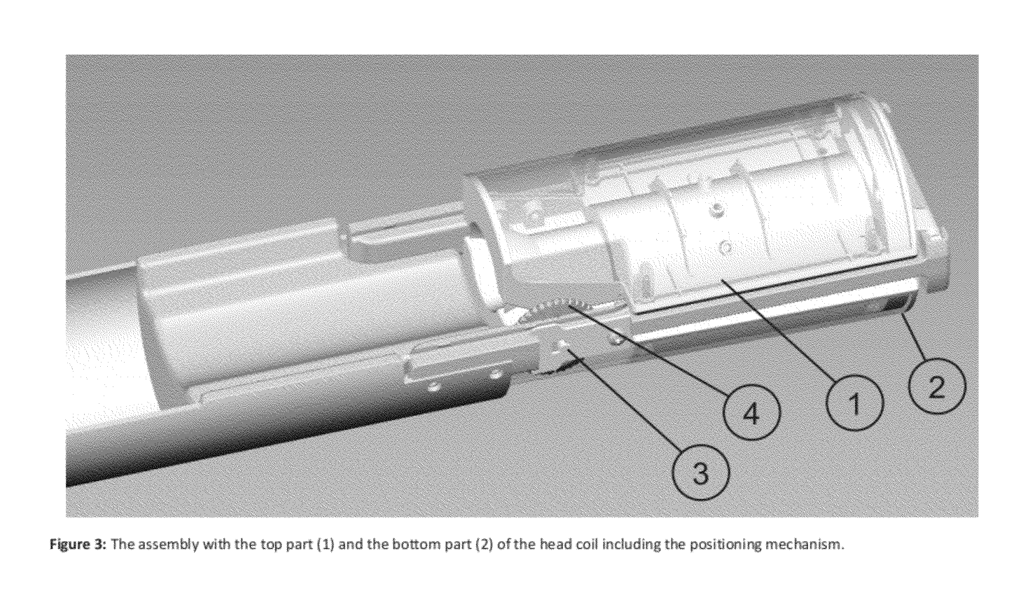

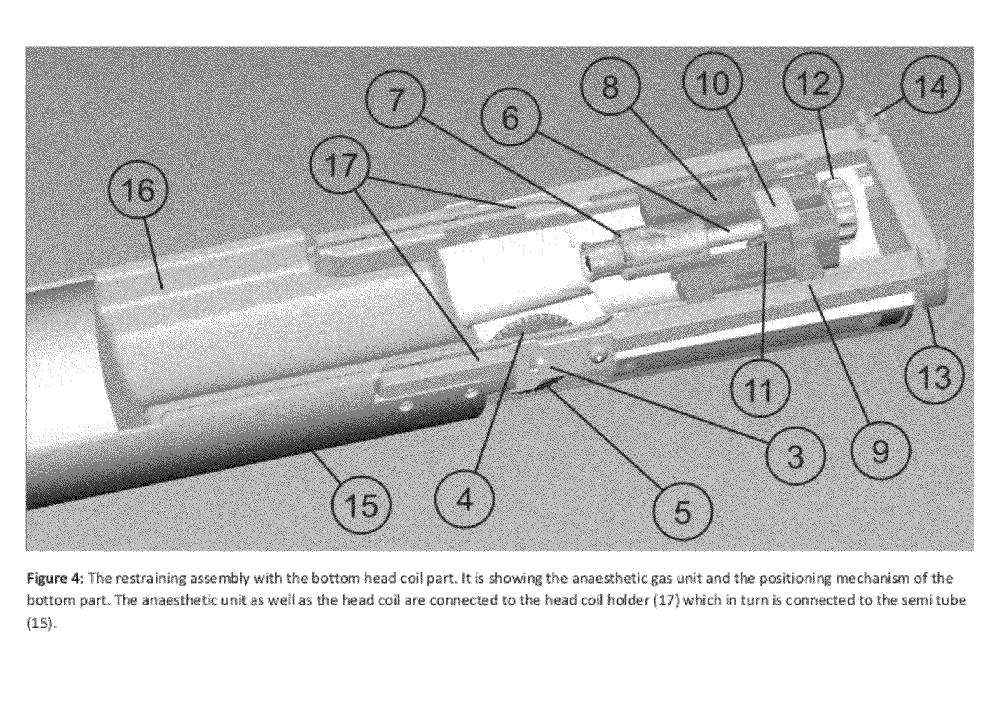

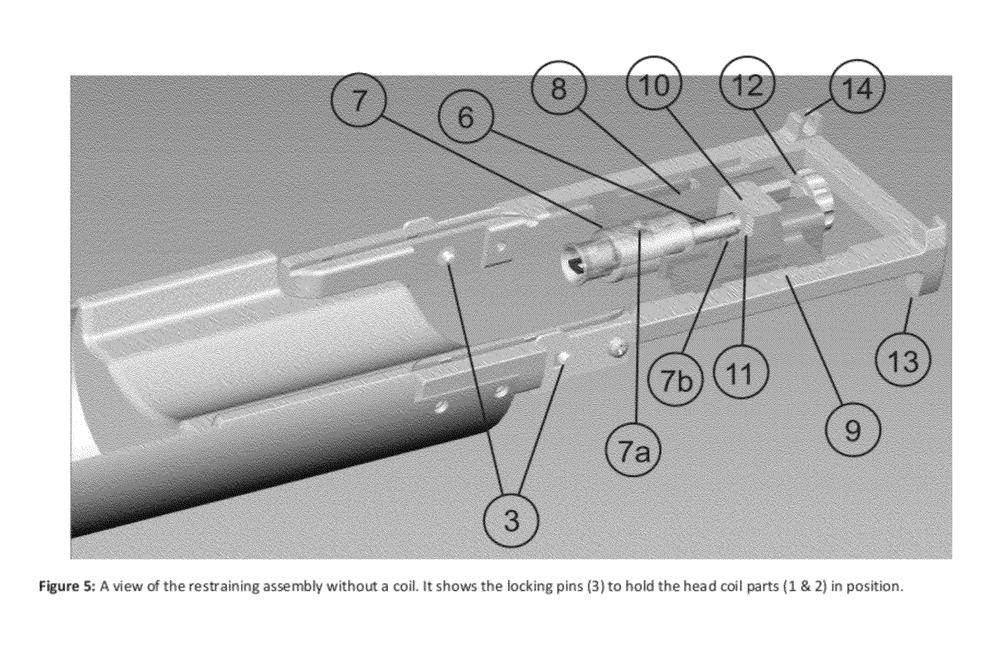

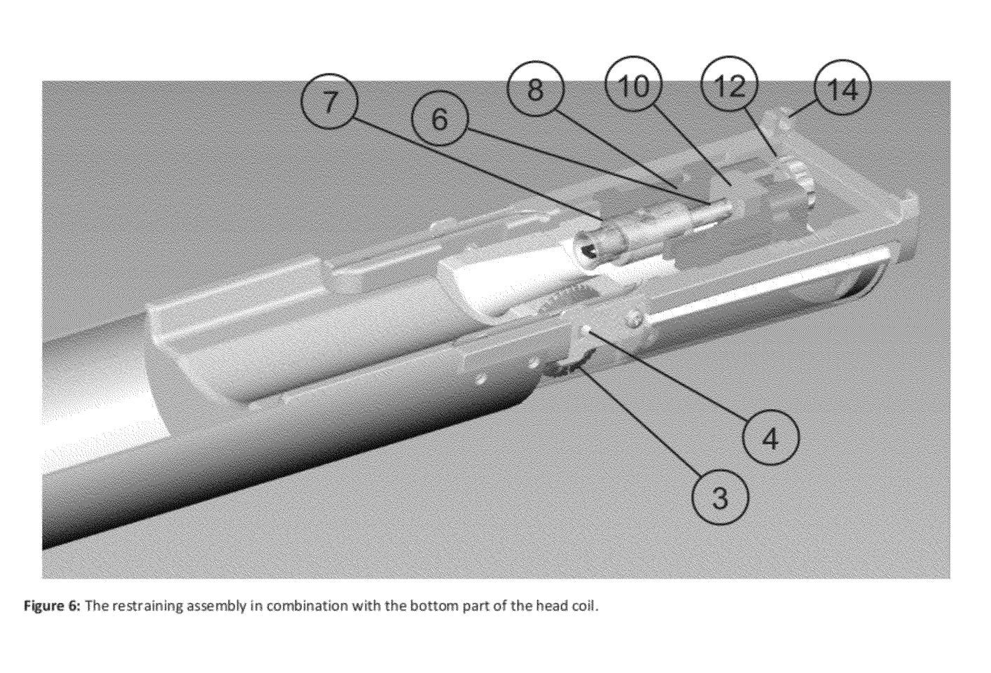

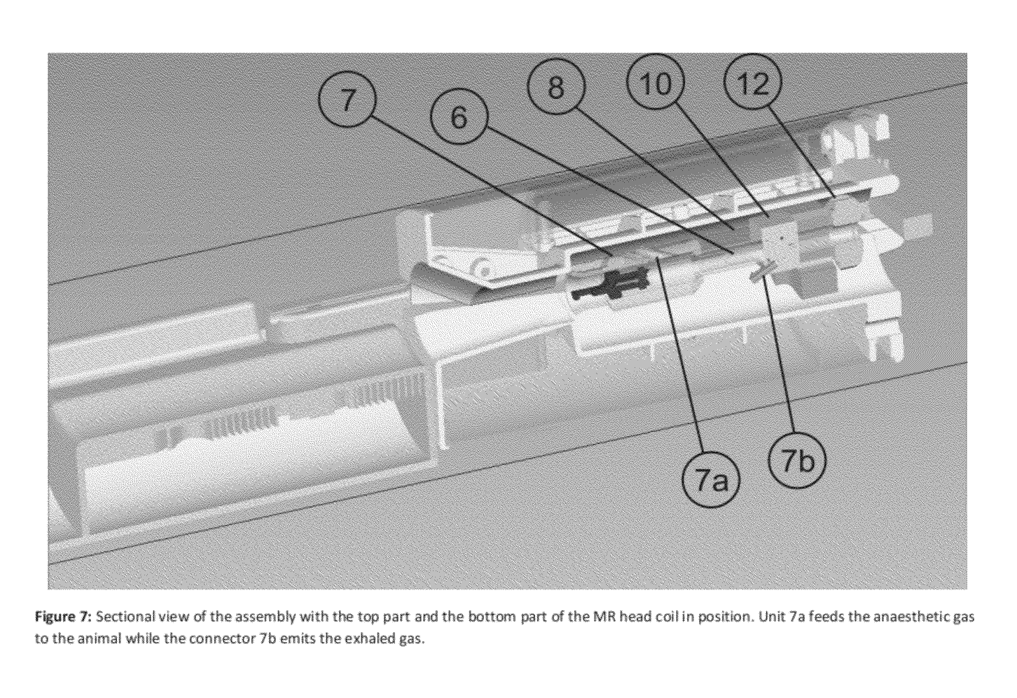

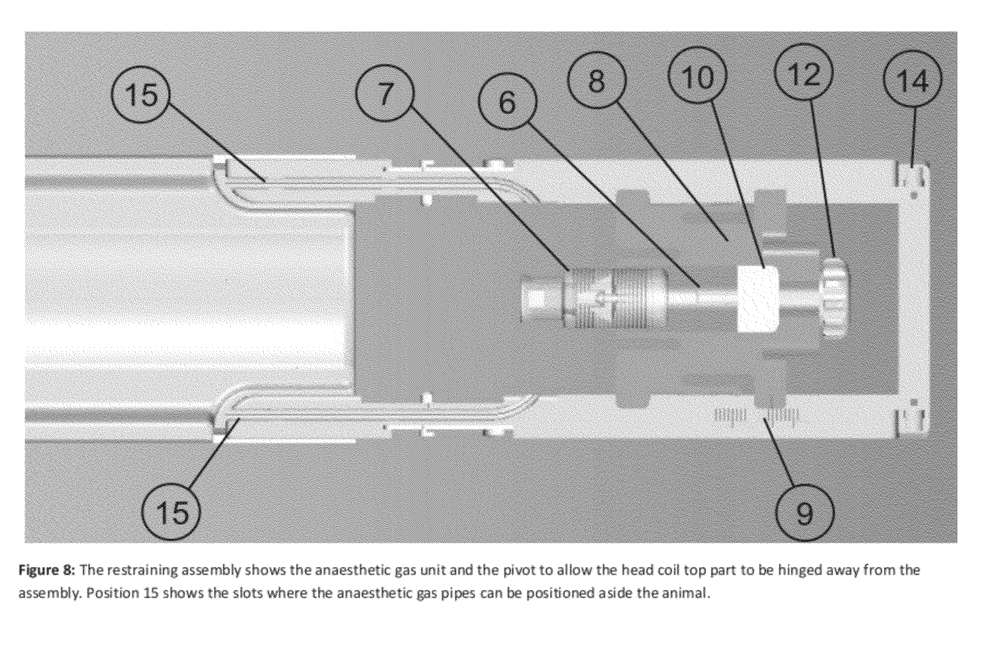

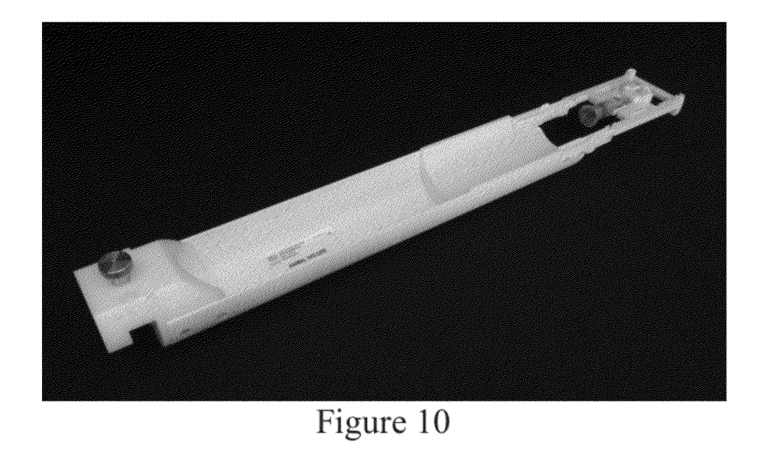

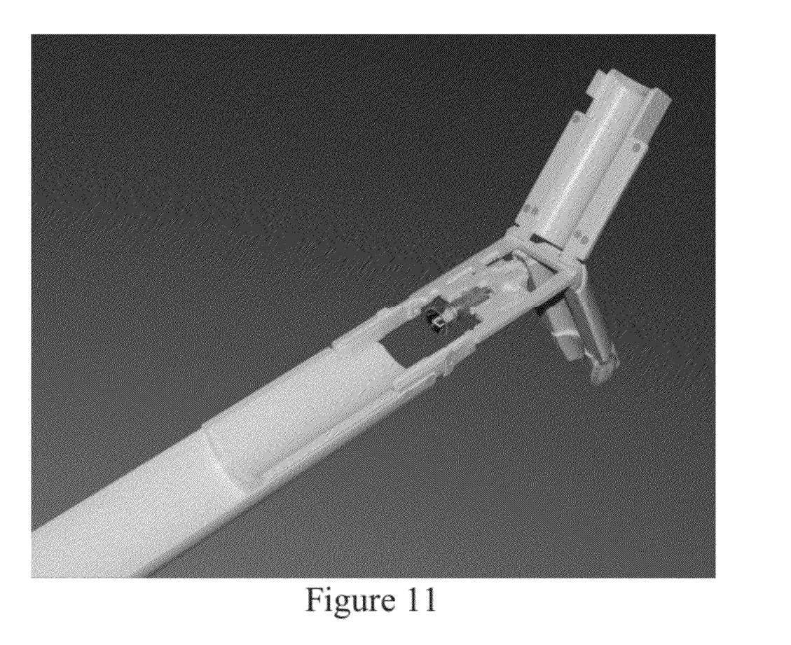

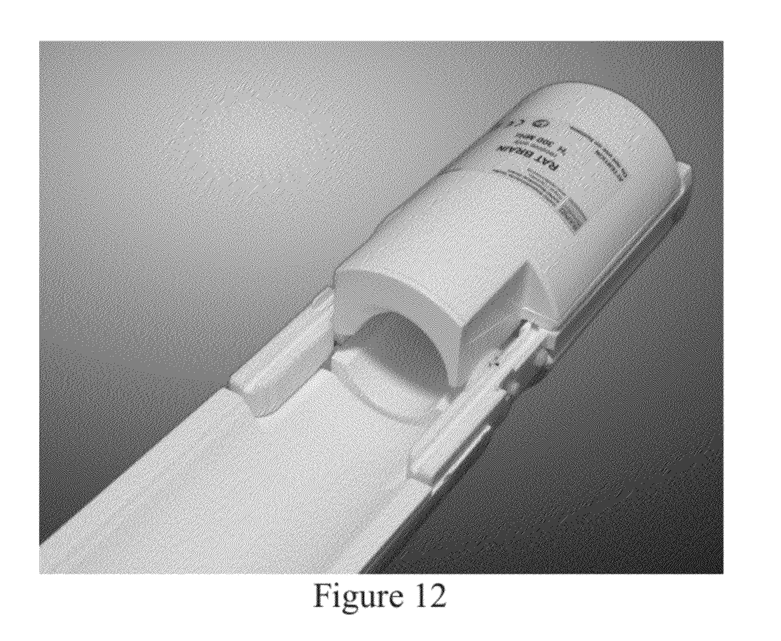

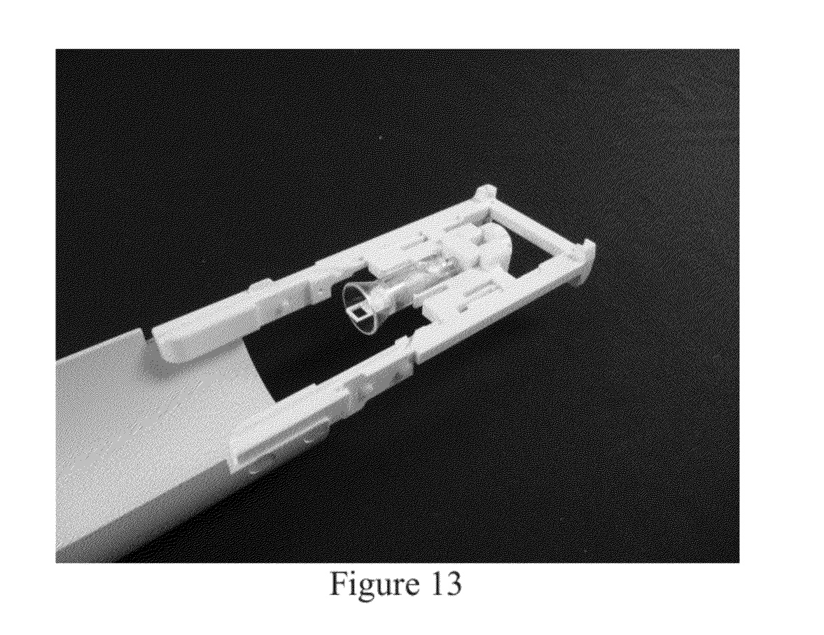

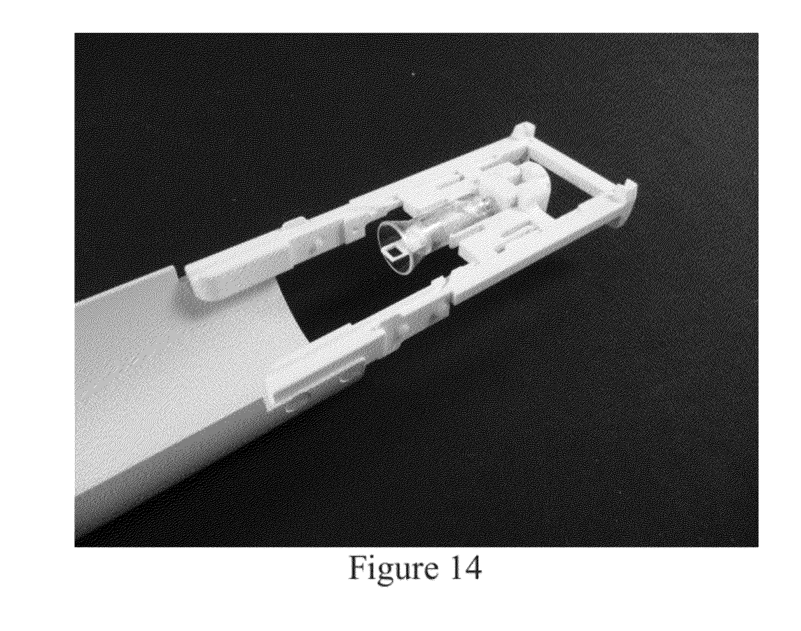

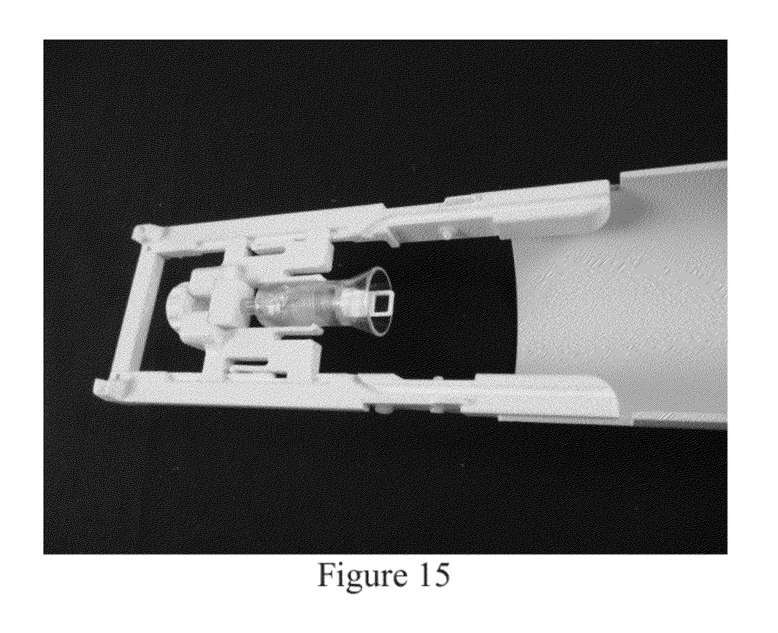

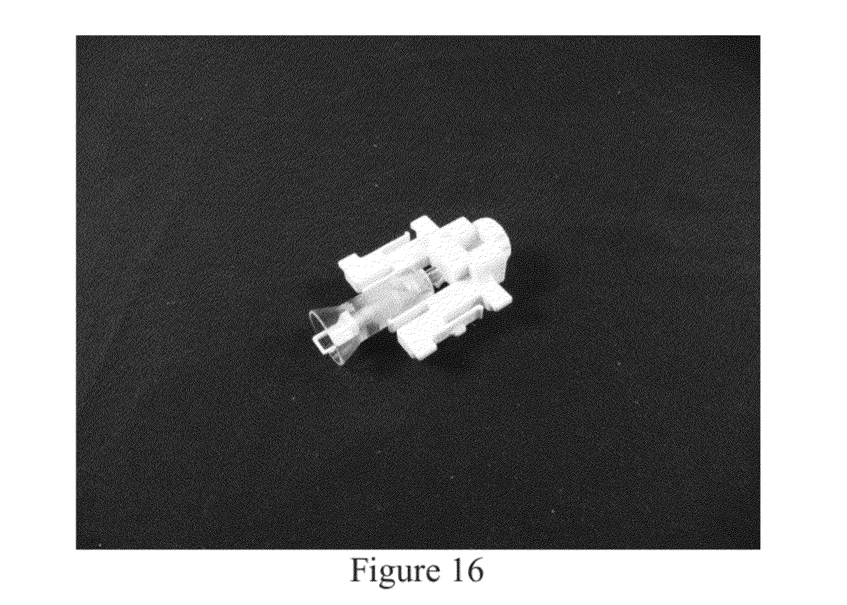

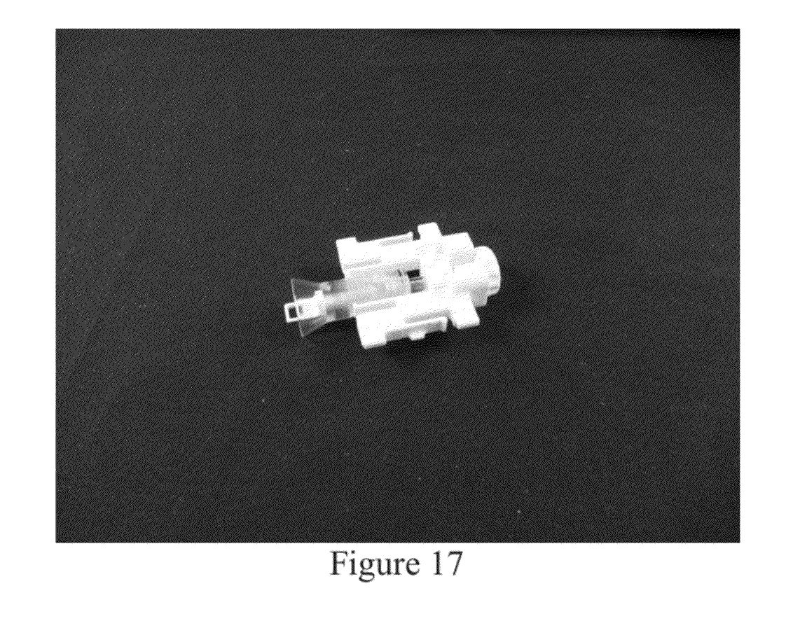

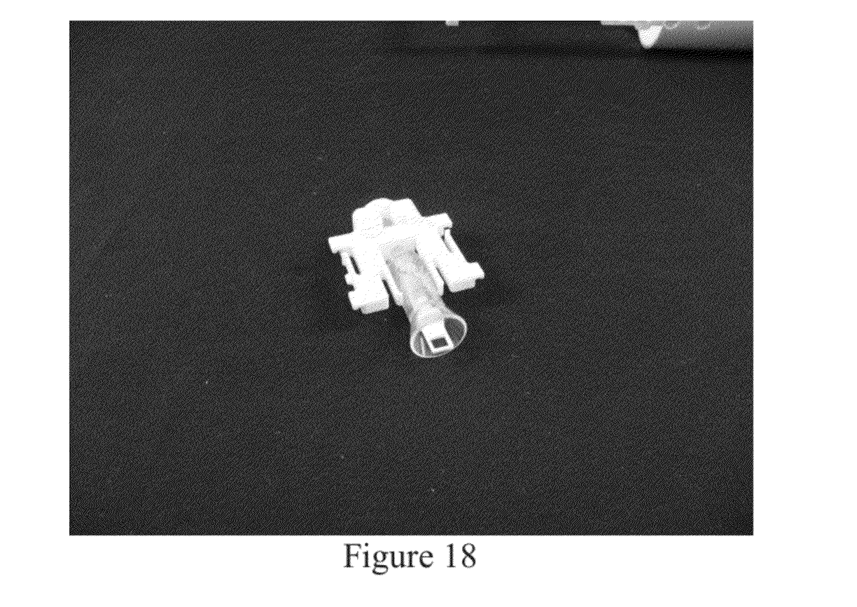

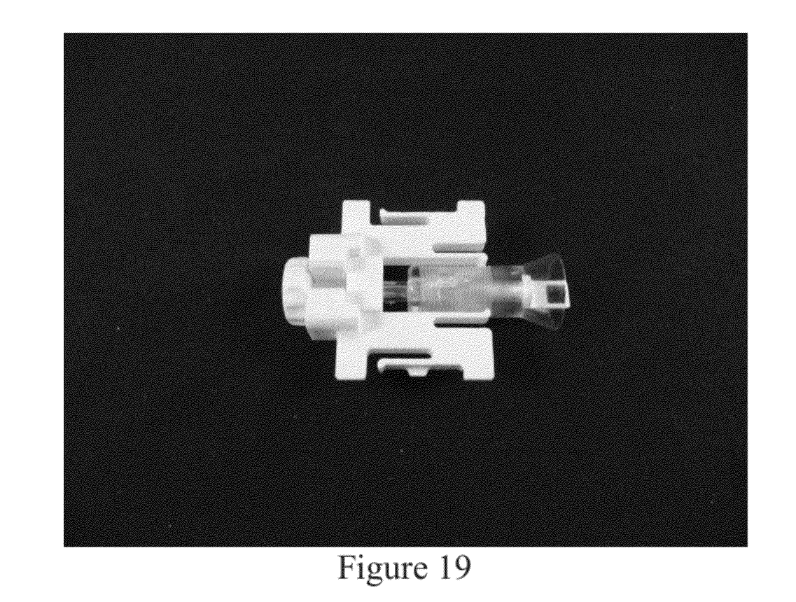

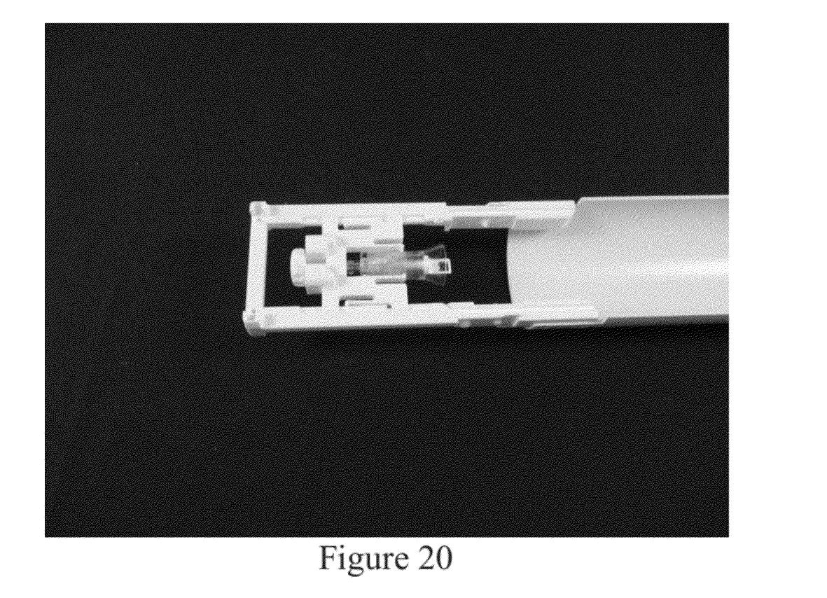

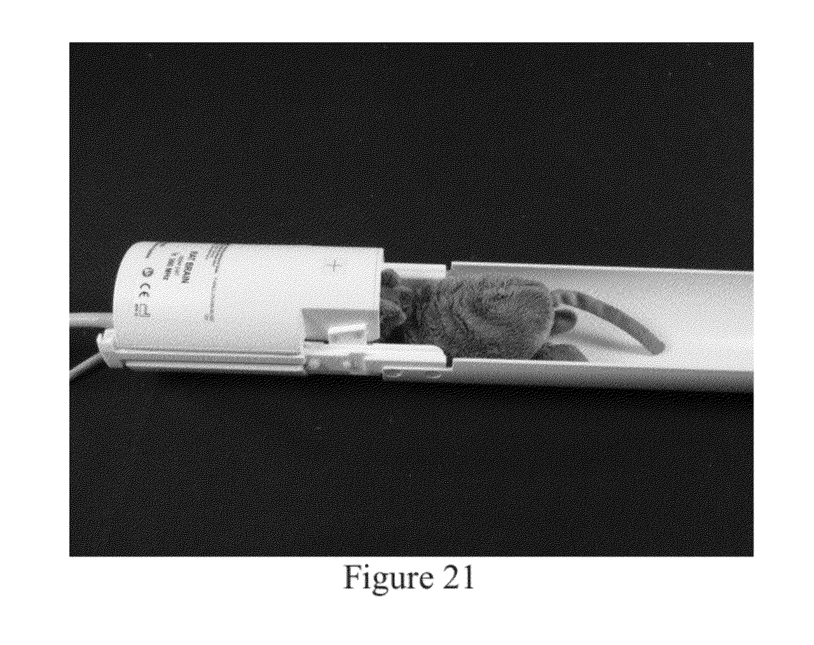

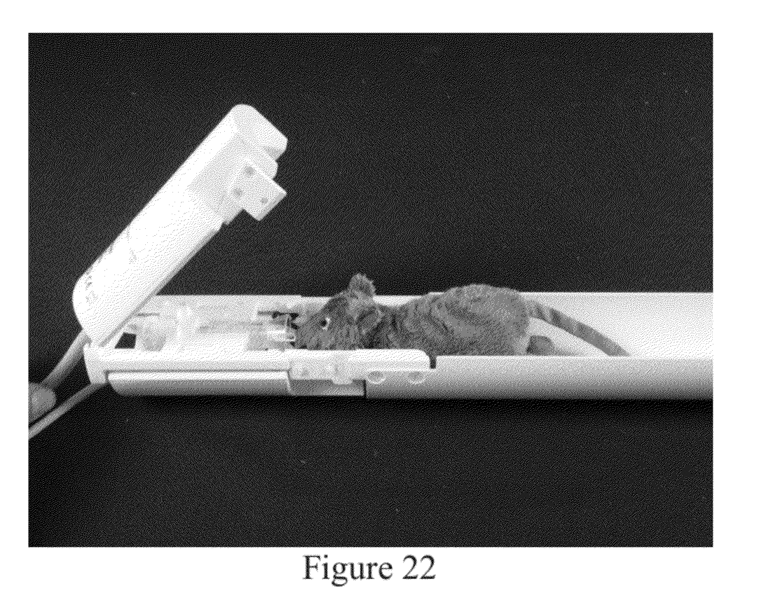

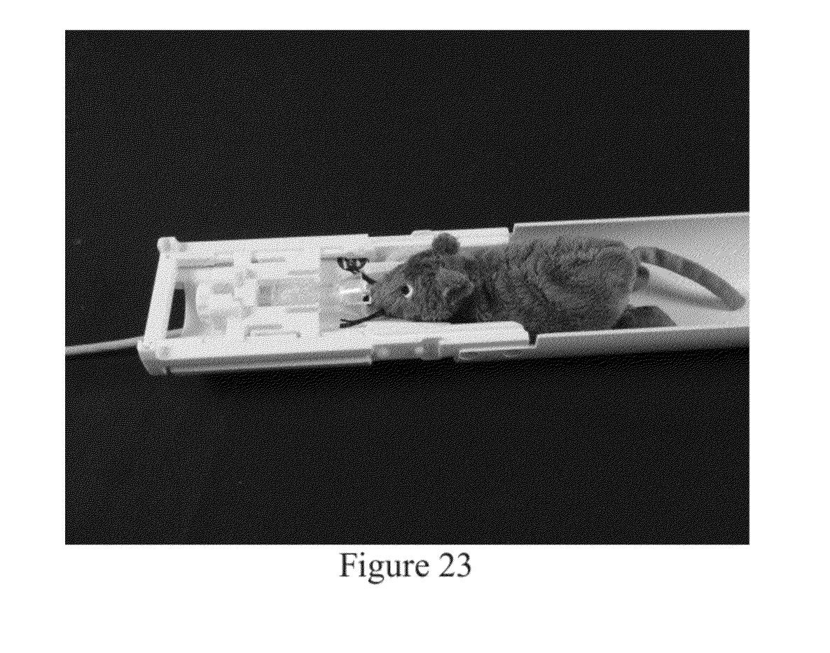

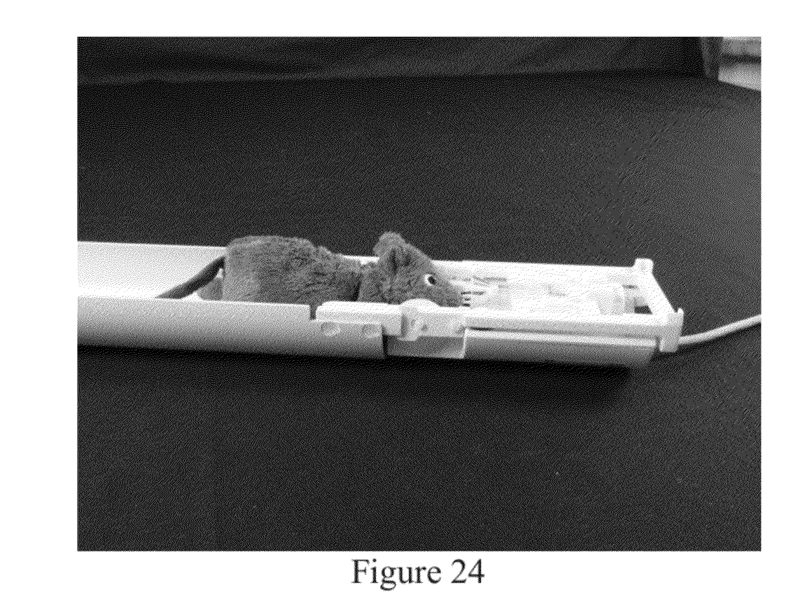

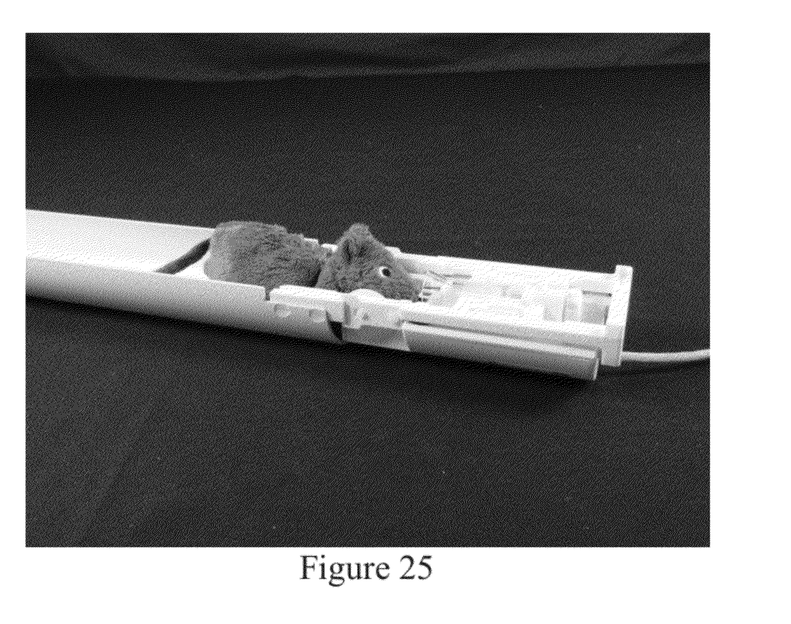

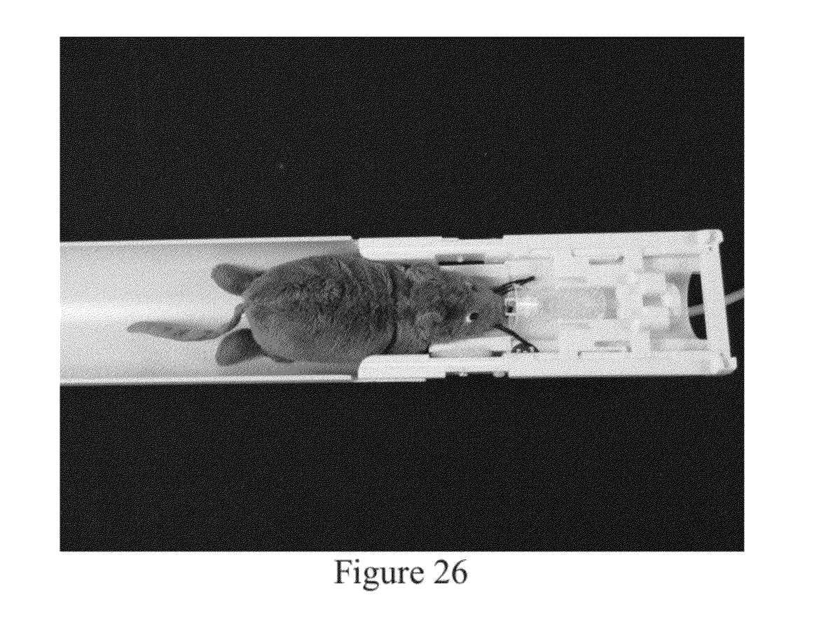

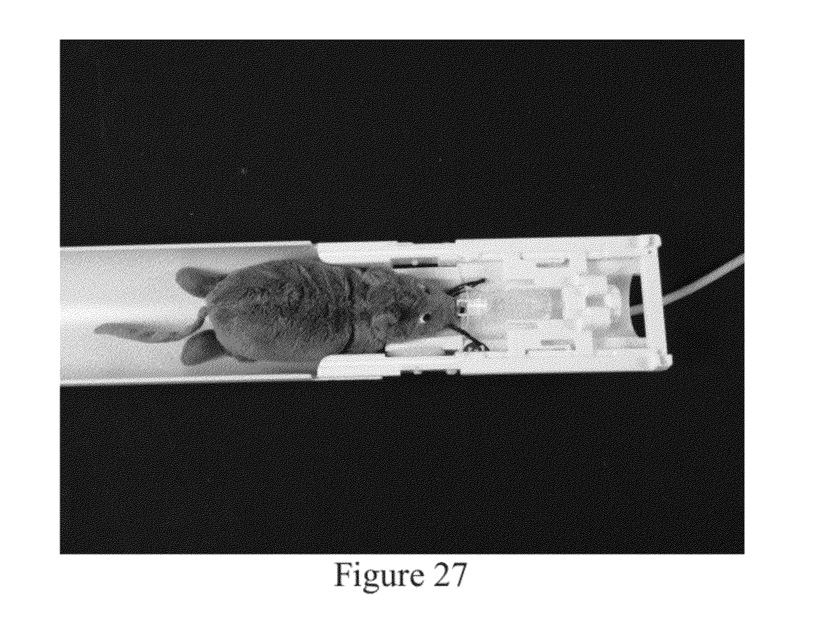

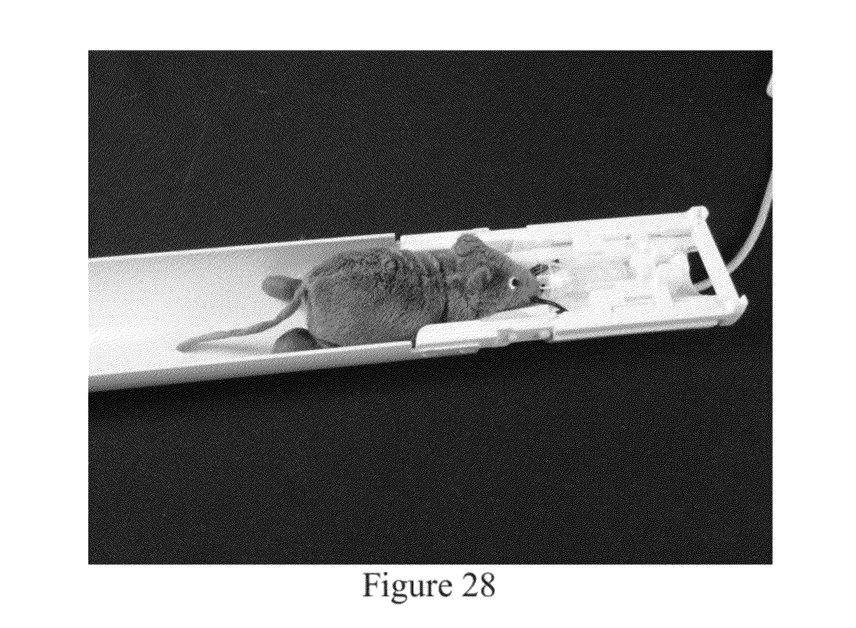

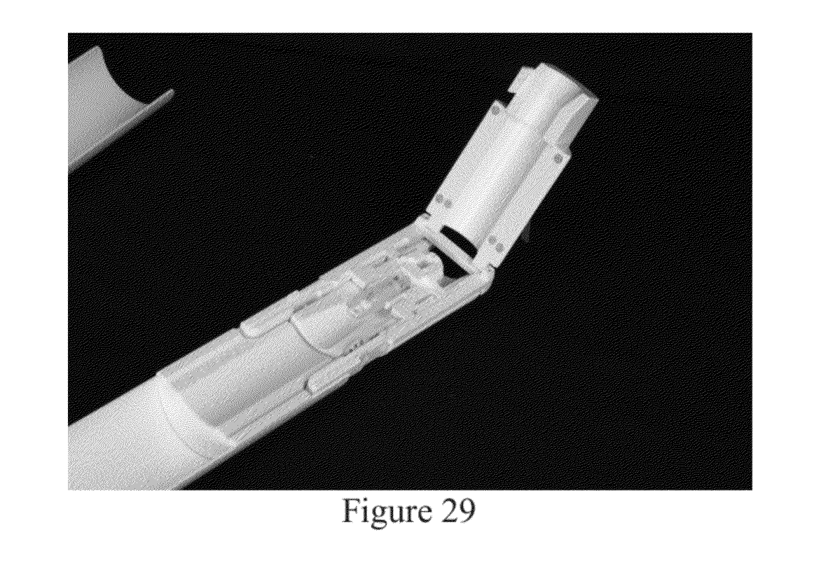

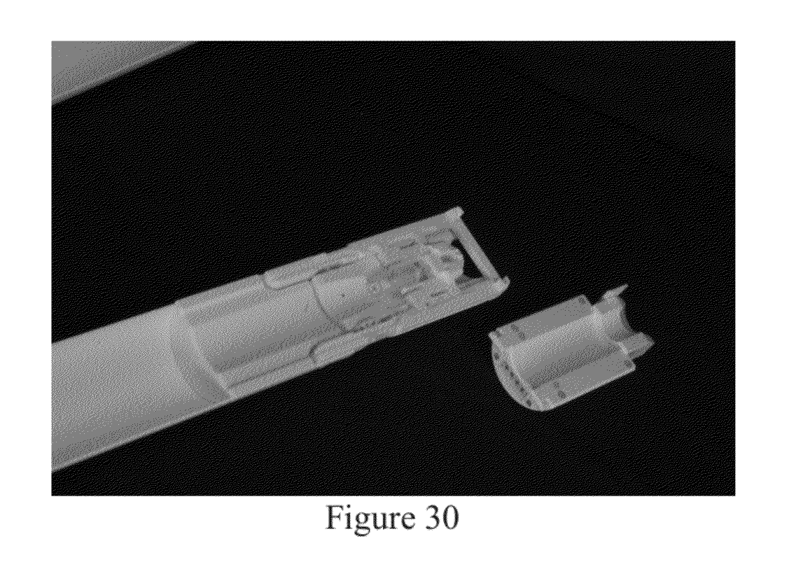

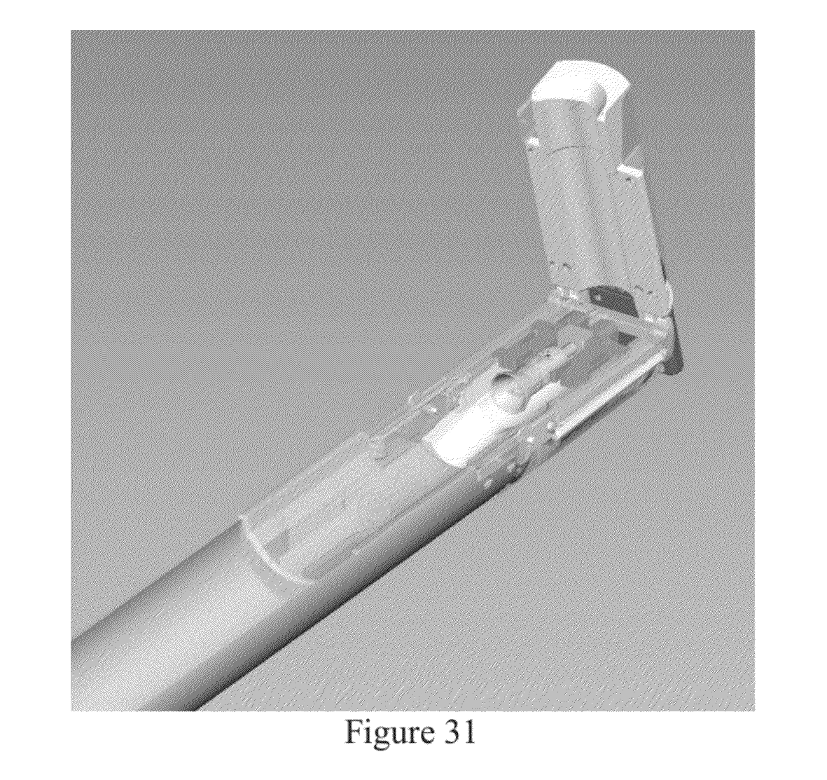

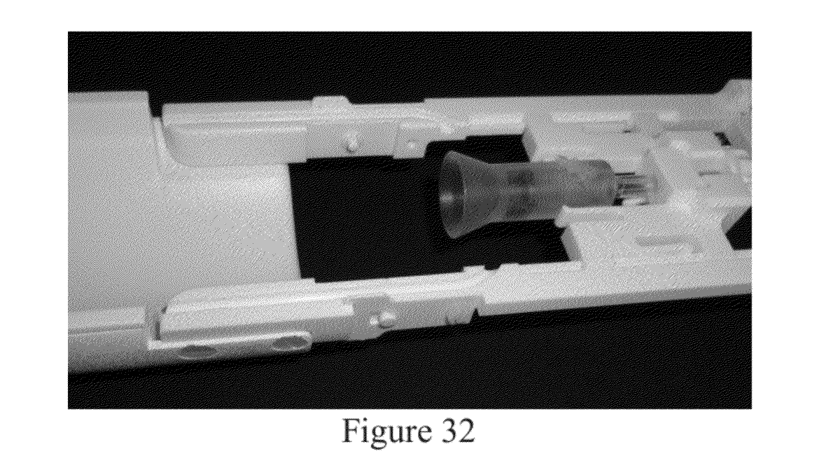

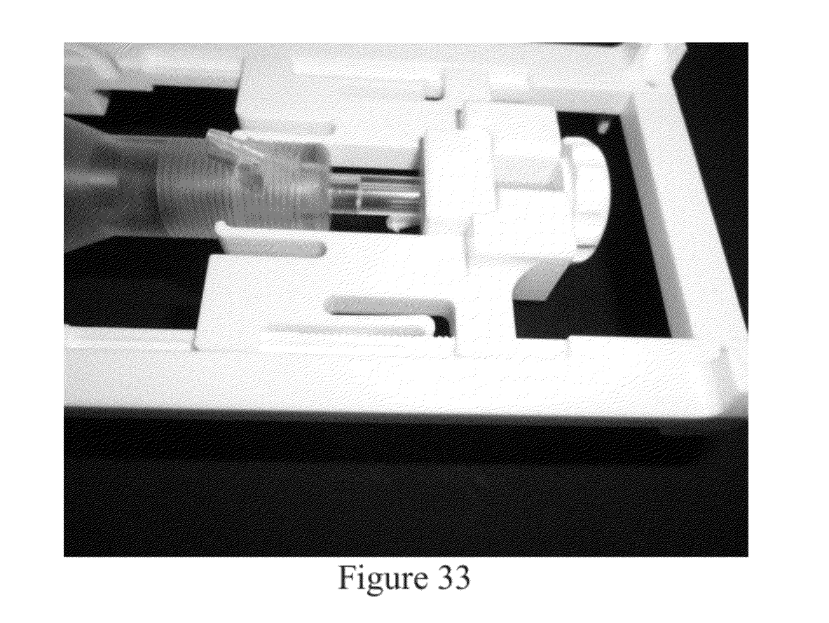

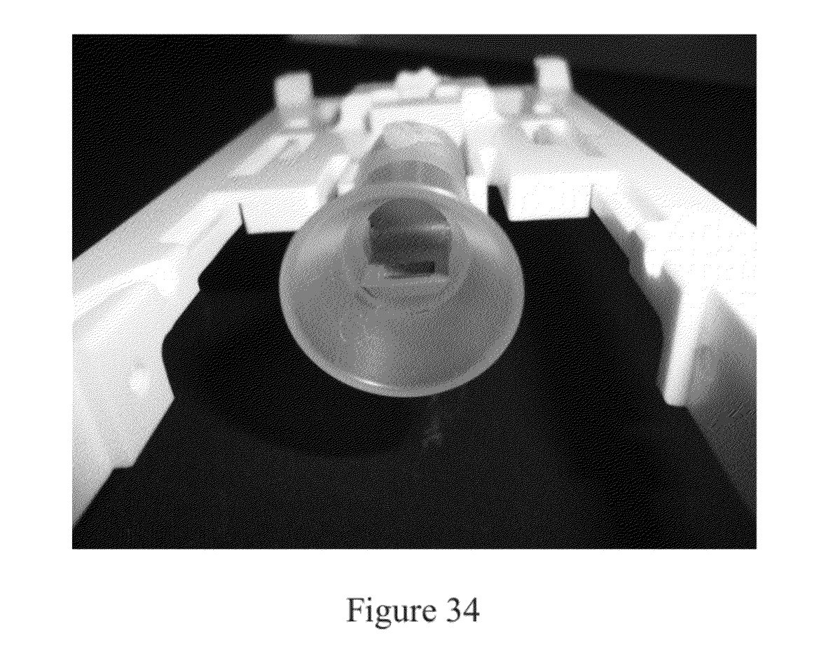

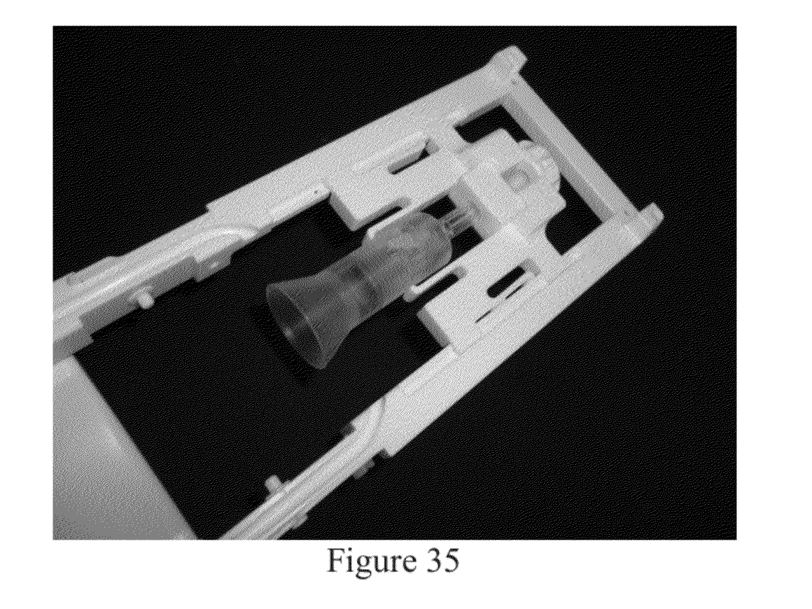

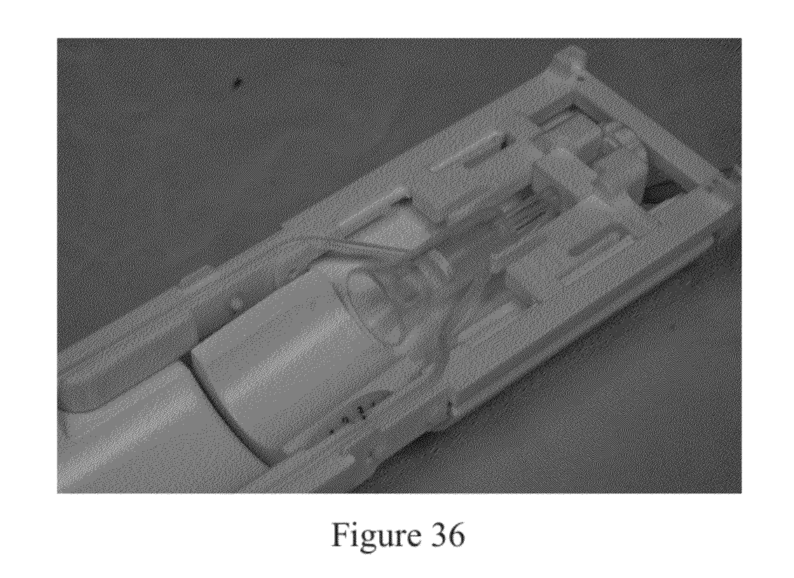

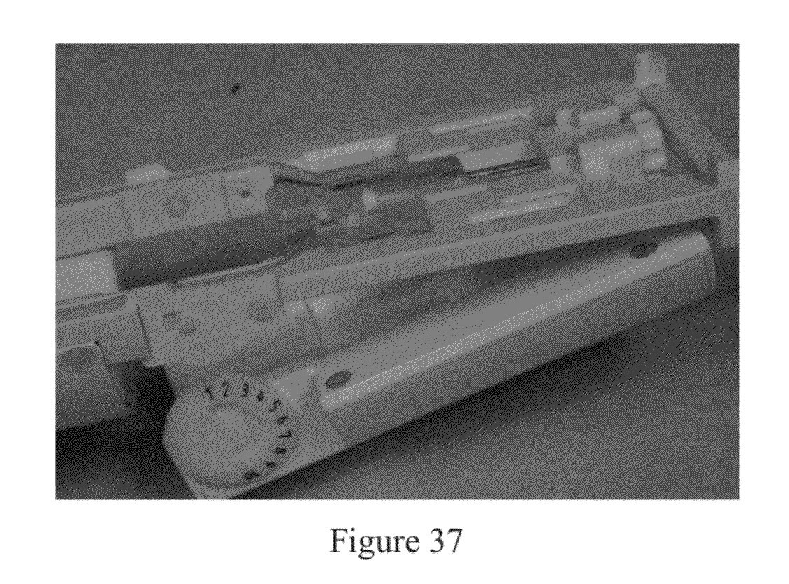

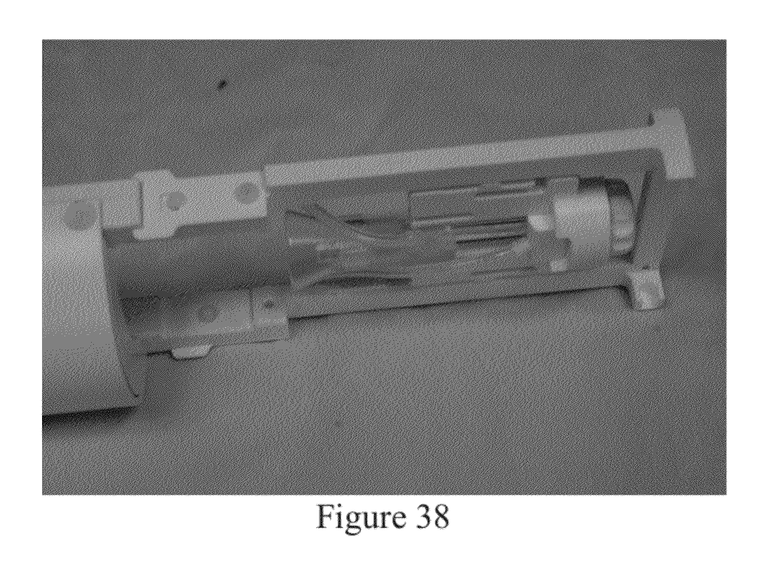

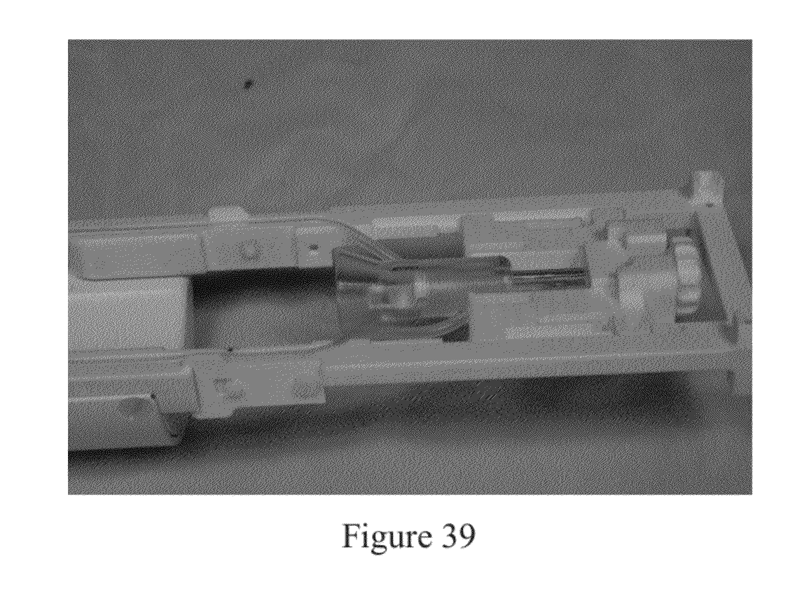

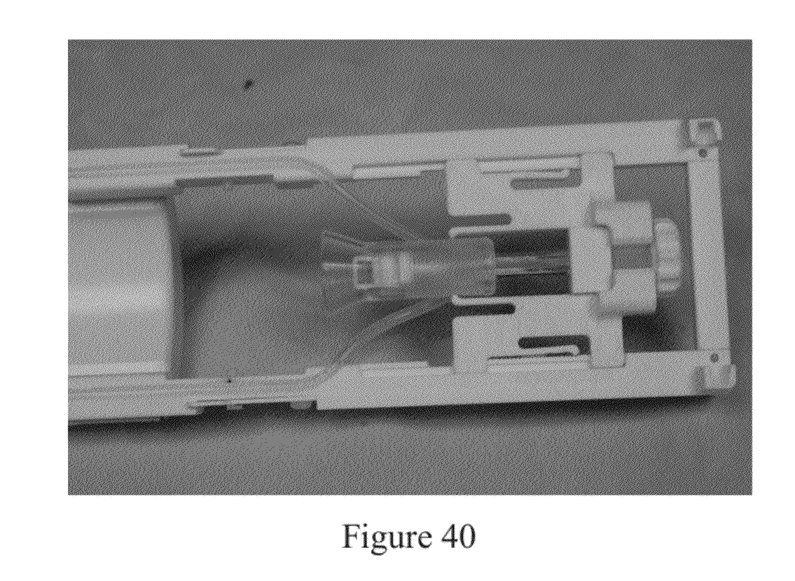

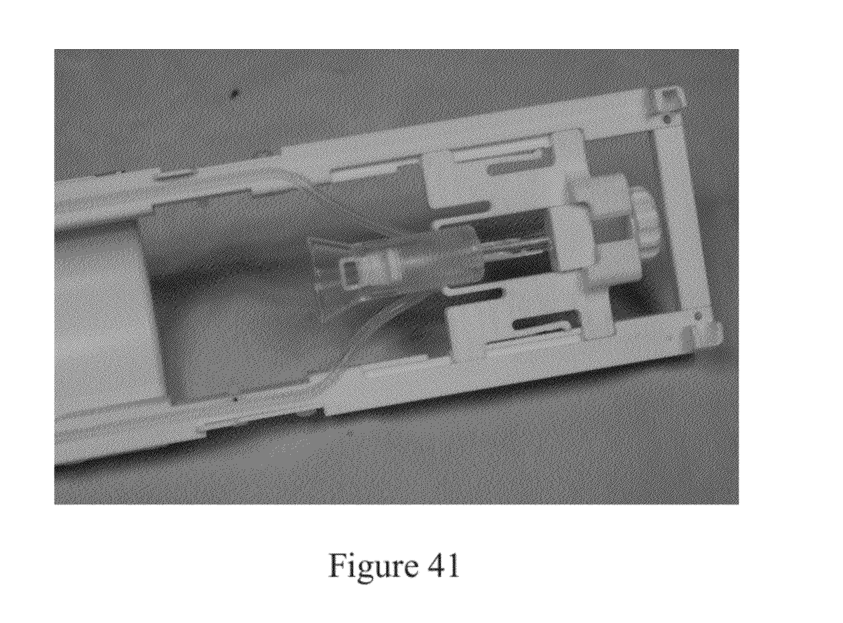

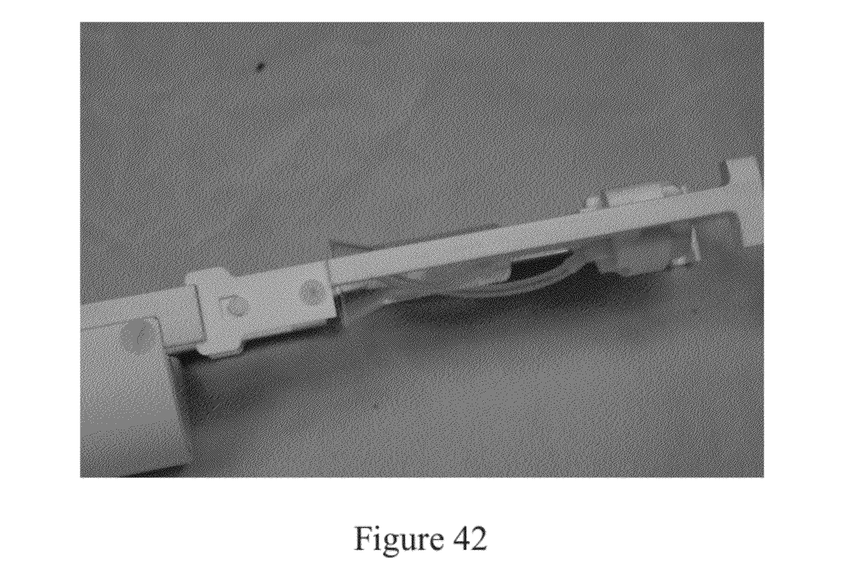

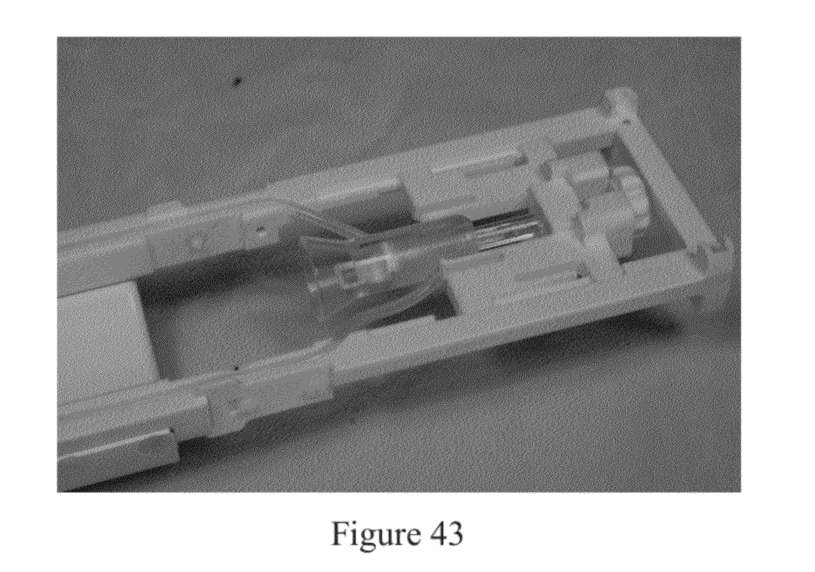

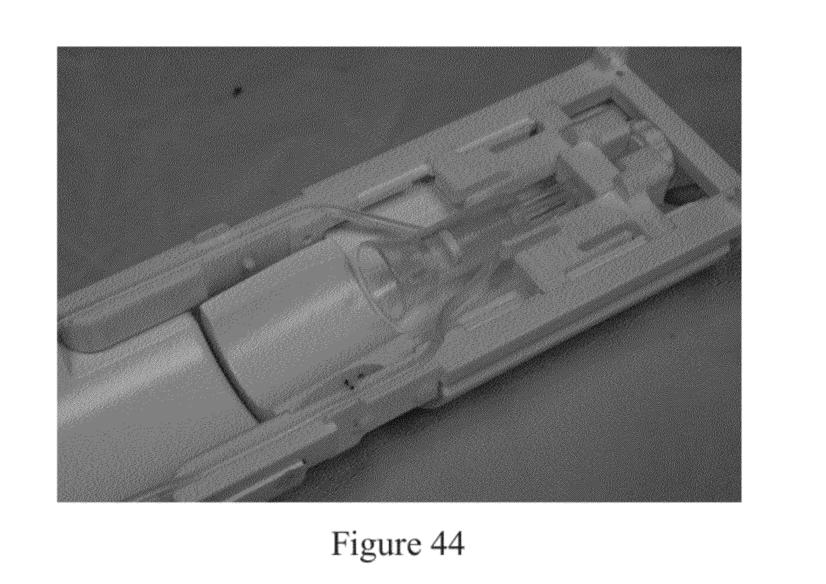

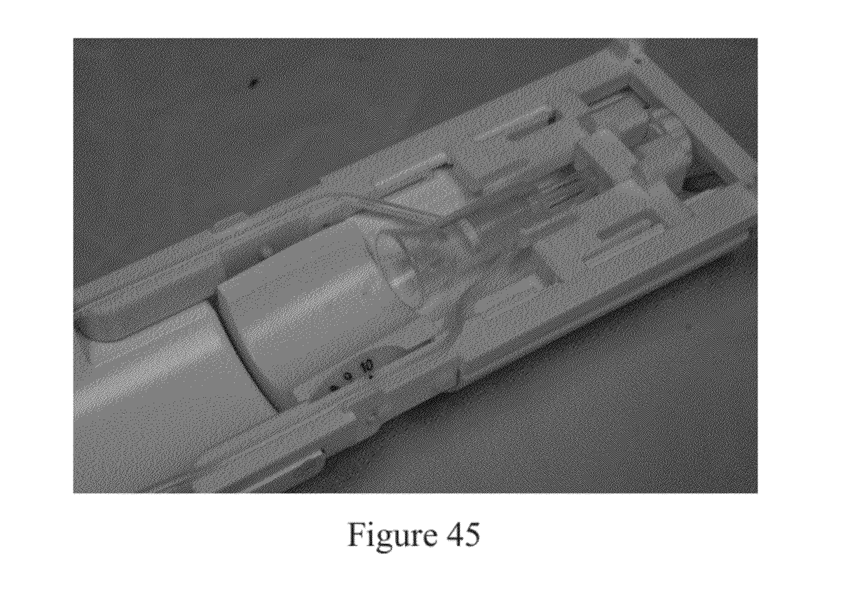

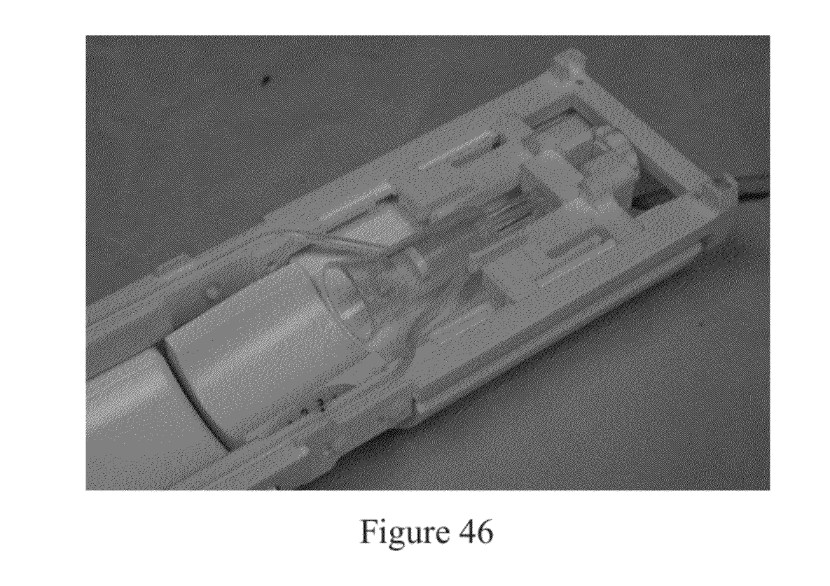

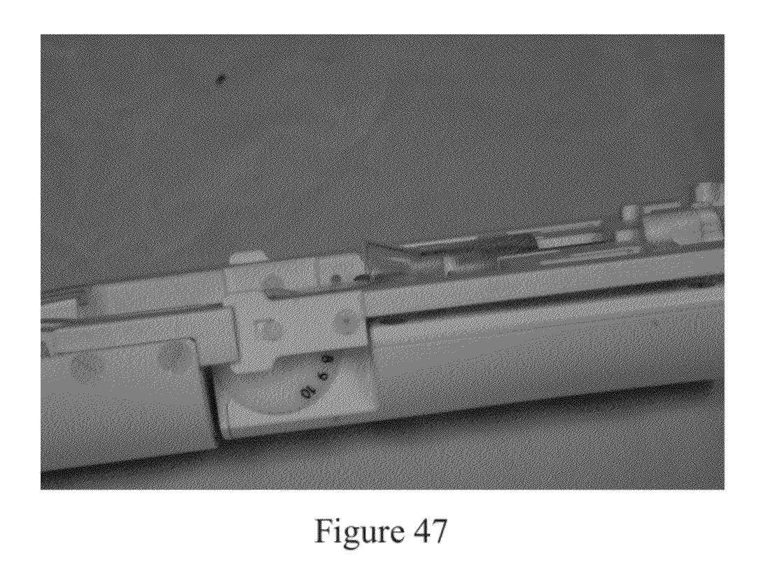

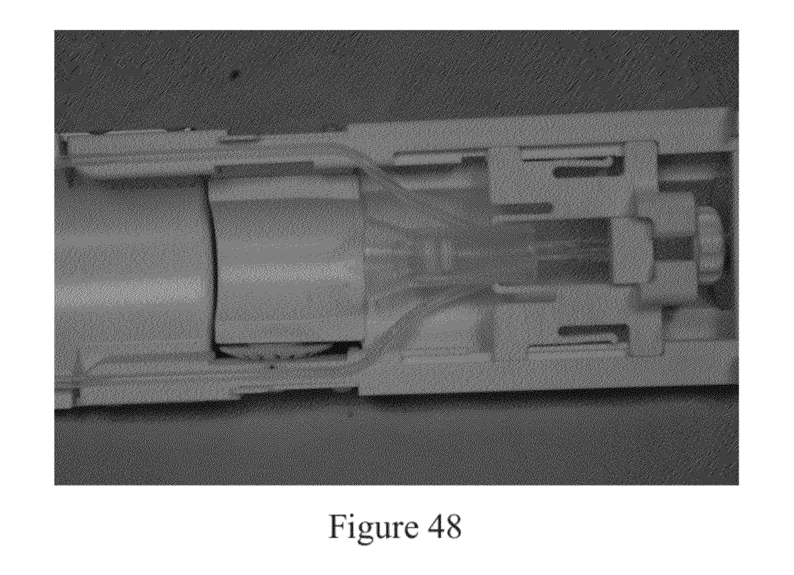

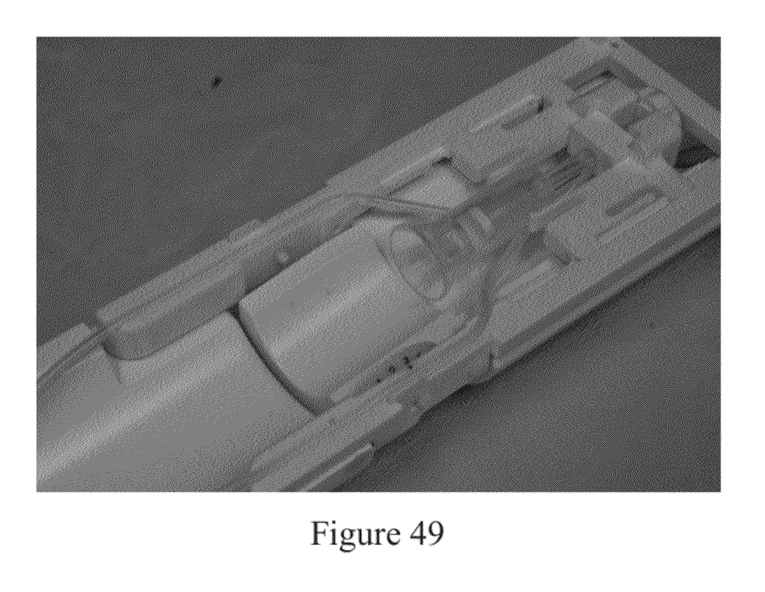

Provided is an example embodiment comprising a combined array coil including a top and a bottom part. The two coil parts can be separated from the coil holder to allow for a correct sample positioning. Each of the coil parts can operate as one or more separate channels for the imaging signal(s). The array parts can be adjusted to the size of the sample, so that the animal head is fixed in position and also to obtain a maximum filling factor and optimum SNR. FIG. 1 to FIG. 9 show drawings of such an assembly to image an animal head. FIGS. 10-49 provide photographs of such an assembly, some showing the assembly in use. This example assembly is for neuroimaging of an anesthetized animal. The animal is held in position by the use of three mechanisms that are very quickly implemented and minimise the set-up time and so reduce the stress for the animal. This assembly also allows for a relaxed work-flow without the need for time consuming stereotactic positioning of the animal.

With the new workflow, the teeth of the animal are placed inside the catch of the tooth bar 6. Then, the anaesthetic gas mask is slid over the snout of the animal. The shape of the mask is ergonomically adapted to the specific animal, and clamps the sides of the snout so that the animal head is locked. The gas mask feeds the anaesthetic agent via the gas inlet 7a to the animal. The used gas is let out on the gas outlet 7b.

Alternatively, the animal can be anaesthetized utilizing the anaesthetic unit previously removed from the assembly. Then, the animal with the anaesthetic unit is placed in the assembly where the anaesthetic unit is simply clipped into the coil holder 17 and positioned. This allows interventional applications and, for example, intubation of the animal. The straightforward installation of the anaesthetic block also allows it to be easily exchanged for another sized unit (e.g. exchange between rat and mouse).

The position of both the tooth bar and the gas mask can be freely adjusted with the horizontally sliding anaesthetic holder 8, and the vertical sliding anaesthetic block 10. Each of those mechanisms incorporates a scale 9, 11 to allow reproducible positioning.

The animal head should be positioned so that the skull is placed directly against the bottom of the top part of the array coil 1. This position can be further secured by adjusting the height of the bottom part of the array coil. Its inner shape is anatomically formed so that the head of the animal is well supported. The height of the bottom part of the array coil 2 is adjusted depending on the size of the animal head. This is done easily with the adjustment wheel 4. After this adjustment, the final position of the tooth bar and the gas mask is locked by tightening the locking wheel 12.

This set-up allows for a large range of adjustments. The described work-flow positions the head of the animal securely with little effort, and in very little time compared to the previously described state-of-the-art procedure. This minimises stress to the animal, and reduces the set up time. It also increases the throughput for a more efficient use of the equipment. The adjustable positioning allows a flexible set up of the assembly while the scaling ensures reproducible positioning.

Both the top part and the bottom part of the head coil can include a pre-amplifier for amplifying the signal obtained by the respective part. Such an amplifier can be provided within the housing of each of the parts, or provided outside of the housing.

Both, the top part and the bottom part of the head coil can be hinged away from the assembly to give access to the animal. The pivot 13, 14 is located in the holder of the array coil 17. Using the wings, the locking pins 3 can be pulled outwards and each array coil part can be hinged away giving free access to the anaesthetic unit (and the positioned animal). To lock the coil parts again in the adjusted position, they are clipped back again and will lock automatically when the pin is latched.

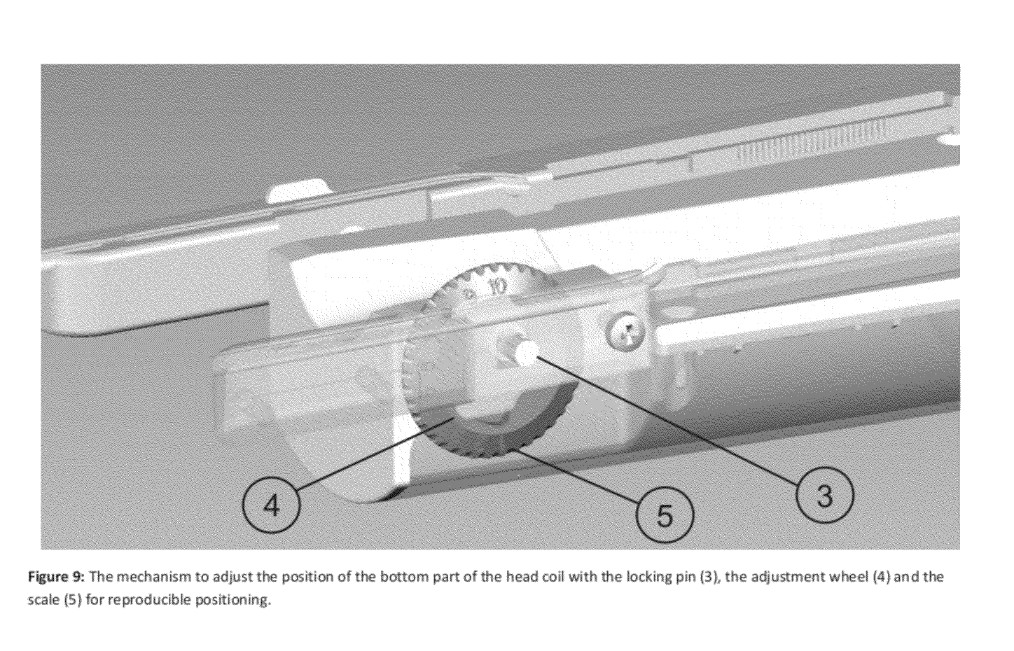

The top part of the array coil locks when the pin falls in a hole placed in a hook on the side of the assembly. The adjustable bottom part of the coil is locked when the pin 3 falls in the spiral shaped notch in the adjustment wheel 4 (see FIG. 9). This spiral shaped notch allows the adjustment of the height of the bottom part of the coil. By turning the adjustment wheel, the horizontal position of the notch (and the locked pin) changes. A friction plate that also acts as hub for the adjustment wheel increases the force needed to turn the wheel, and so avoids unwanted changes of the bottom coil part position.

For neuroimaging, it is desirable to have a good Signal to Noise Ratio (SNR) so it is desirable to use surface coils. Here, coil arrays have developed rapidly over the last few years. However there are practical limitations with the use of array coils as the available space is limited so that only a small number of array elements can be implemented around a small animal head.

By the use of a split (top and bottom) array, we use the excellent SNR of surface coils and combine it with the good homogeneity of volume coils. The sensitivity profiles of the top and bottom coil parts superimpose and produce much more homogeneous signal intensity. The coil adjustment allows a positioning of the array parts according to the actual\ size of the animal and, thus, optimizes the filling factor of the coil. For the investigation of sub-surface structures within the animal head, an additional coil spacing of only a few millimetres can reduce the filling factor dramatically, and can easily result in an SNR drop of 20% or more. A good homogeneity is very important for qualitative measurements and QA set-ups. Here, a small positioning error can lead to large changes in the signal intensity and affect the measurement.

With the use of the two coil parts, twice the number of coil elements can be implemented allowing one to maximise the overall SNR (a 40% increase has been observed in the centre of an animal head), and increase the signal homogeneity. For MR neuro-imaging applications, mostly the animal brain is investigated. In this case, the top part of the array will produce the most NMR signal due to its proximity. However, the bottom part of the array will still distribute signal to the lower part of the brain, and keep the signal intensity much more constant over the imaging volume than with only surface coil positioned on top of the skull.

With the symmetrically split array coil arrangement, it is also possible to easily implement quadrature MR transmit coils. In this case, the transmit field is composed of two orthogonal components of similar amplitude, but with a 90° phase shift. The corresponding coils can be easily accommodated in the split coil design.

Quadrature coils can be utilized in order to gain SNR. For this, two geometrically orthogonal coil elements are combined via a quadrature hybrid, including a 90° phase shift. The typical gain of SNR by quadrature coils is up to a factor of 1.4. This technique can be applied to the disclosed embodiments doing either a single quadrature channel and leaving the others in linear operation, or doing even more than one channel in quadrature operation. The choice of number of channels might depend upon the geometry and size of the coil elements, the orientation in the static magnetic BO field, or the loading condition of the object under investigation. See Haase et al. “NMR probeheads for in-vivo applications; Concepts of Magnetic Resonance” pp 361 (2000) incorporated herein by reference.

The described assembly is designed so that the animal is positioned with the body placed on top of an animal bed 16. This bed can be used as a heating mat to control the animal's body temperature and keep it constant. The temperature is adjusted by the means of heated air that flows through one or more parts of the assembly. This heated air can also flow completely or only partially inside the volume transmit coil in which the herein described assembly is usually placed for MR investigations.

Similar arguments as with the head array apply for MR investigations of the animal's heart. In this case, a split coil design is used with a bottom part where the animal lies on and a top part that is positioned once the animal is brought into the correct position. Here, some small spacing between the animal and the top part of the heart should be allowed for as there will be some breathing motion. Alternatively, a flexible coil design can be used to adapt the coil shape to the imaged animal and allow for cardiac and respiratory motion. This is particularly useful when animals of different sizes are examined. The weight of rats, for example, can vary by a factor of 5, so that it is important to be able to adapt the coil shape, size and position to the imaged animal. Such set-up with a bottom part and a top part of the heart array, with the option of a flexible coil housing, provides an increased filling factor and enhances the image SNR.

The heart array is anatomically shaped and positioned instead of the animal bed. The heart array can also be used to control the animal's temperature with the means of heated air that flows through the structure. Both, the head coil and the heart coil can be positioned and operated independent from one another. Here the operator can freely decide throughout the experiment which investigation (head or brain) should be performed next.

The invention has been described hereinabove using specific examples and example embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

What is claimed is:

1. An apparatus for supporting the imaging of an animal, comprising:
an animal bed;
a first part positioned with said bed for supporting a part of the animal and receiving a first imaging signal from a first portion of the animal; and
a second part connected to said bed for receiving a second imaging signal from a second portion of the animal, wherein
said first part and said second part are separately moveable with respect to said animal bed.

2. The apparatus of claim 1, wherein said first is adjustable in height with respect to said Bed and wherein said second part includes a removable connection for connecting to said bed for allowing removal of said second part from said bed.

3. The apparatus of claim 1, wherein said first portion of the animal is an upper portion of the animal including the head and/or torso of the animal and wherein said second portion of the animal is a lower portion of the animal.

4. The apparatus of claim 1, further comprising an adjustment mechanism for adjusting a height of the first part to accommodate the size of the head of the animal.

5. The apparatus of claim 4, wherein said mechanism is adapted such that an adjustment of said mechanism is reproducible when the animal is removed from and then replaced in said apparatus.

6. The apparatus of claim 5, wherein said mechanism includes a scale for indicating a height position.

7. The apparatus of claim 4, wherein an inner portion of said second part is anatomically formed to accommodate and fixate the head of the animal.

8. The apparatus of claim 1, said mechanism comprising an adjusting wheel, a horizontally sliding anesthetic holder, and a vertically adjustable anesthetic block, wherein a height of the first part of the array coil can be adjusted with an adjustment wheel and where the adjusted position can be locked.

9. The apparatus of claim 1, wherein said part of the animal supported by said first part is at least a part of the head of the animal.

10. The apparatus of claim 1, wherein said first part can be pivoted away from said animal bed in one direction, and wherein said second part can be pivoted away from said animal bed in another direction.

11. The apparatus of claim 1, wherein said first part can be removed from said bed and wherein said device is thereby adapted for use in imaging the animal using said first part without said second part.

12. The apparatus of claim 1, wherein an inner portion of said second part is anatomically formed to accommodate and fixate the head of the animal.

13. The apparatus of claim 1, further comprising:
ear pins for positioning the animal that is anaesthetized; and
a tooth bar in combination with a gas mask for clamping the snout of the animal, wherein
said first part and said second part of said array coil are adapted to be ergonomically shaped to fix the head of the animal in a desired position.

14. An apparatus for supporting the imaging of an animal, comprising:
an animal bed;
a bottom array part connected to said bed and including a first coil adapted for receiving at least one first imaging signal from a lower part of the animal,
a top array part including:
a second coil adapted for receiving at least one second imaging signal from the head and/or torso of the animal,
an inner portion that is anatomically formed to accommodate the head and/or torso of the animal, and
a removable connection connected to said bed for allowing said top part to be removed from said bed; and
an adjustment mechanism for adjusting a height of said first part of said array coil to accommodate the size of the head of the animal.

15. The apparatus of claim 14, wherein both said first array part and said second array part can be pivoted away from each other to permit internal access.

16. The apparatus of claim 15, wherein said first part and said second part are locked into place using a respective first pin and second pin.

17. An apparatus for supporting the imaging of an animal, comprising:
an animal bed;
a bottom array part connected to said bed and including a first coil adapted for receiving at least one first imaging signal from a lower part of the animal,
a top array part including:
a second coil adapted for receiving at least one second imaging signal from the head and/or torso of the animal, and
a removable connection connected to said bed for allowing said top part to be removed from said bed and also for allowing said top part to be pivoted away from said second part;
an adjustment mechanism for adjusting a height of said first part of said array coil to accommodate the size of the head of the animal in a repeatable manner;
an anesthetic unit connected to said bed and provided within said bottom array part and said top array part, wherein when said top array part is pivoted away from said bottom array part, access is provided to said anesthetic unit; and
a head holding mechanism connected to said bed for holding the head of the animal in a fixed position.

18. The apparatus of claim 17, further comprising a friction place interacting with said adjustment mechanism to prevent inadvertent misadjustment.

19. The apparatus of claim 17, further comprising a heart coil array to allow for the option of the animal head or its heart being investigated.

20. The apparatus of claim 17, wherein a heart coil is used for imaging the animal's heart, wherein the heart coil is comprised of a single sided surface design (anterior) or of an anterior and a posterior part in a sandwich setup, and wherein both the top array part and the bottom array part can either be rigid or flexible such that a flexible part allows for optimization of different animal sizes, wherein the top array part, the bottom array part, and the heart coil are used as one entity even if only heart- or only brain investigations are being performed.
